(19) United States
(12) Patent Application Publication
(10) Pub. No.: US 2012/0192620 A1
(43) Pub. Date: Aug. 2, 2012

(54) ANALYSIS AND DETECTION DEVICE

(75) Inventors: Cheng-Huang Lin, Taipei (TW); Chien-Hung Lin, Taipei (TW); Yi-Shiuan Li, Taipei (TW); Yi-San He, Taipei (TW)

(73) Assignee: NATIONAL TAIWAN NORMAL UNIVERSITY, Taipei City (TW)

(21) Appl. No.: 13/103,304

(22) Filed: May 9, 2011

(30) Foreign Application Priority Data
Jan. 28, 2011 (TW) 100103268

(51) Int. Cl. G01N 29/14; G01N 30/02

(52) U.S. Cl. 73/23.35; 73/24.01; 73/24.06

(57) ABSTRACT

The present invention provides a novel analysis and detection device, which includes a separation unit for separating a plurality of single-component gases from the mixed components of a gaseous sample; a detection unit for producing a sound signal in response to a corresponding one of the single-component gases; and a signal receiving unit for transferring the sound signal into an electronic signal. The device of the present invention uses gas chromatography principle to separate mixed components of a gaseous sample, a plurality of single-component gases are formed to be detected, a sound signal is formed in response to a corresponding one of the single-component gases, and the components and their amounts are determined according to occurrence time and frequency of the sound signal. The present invention is applicable to a rapid detection and a quantitation analysis of a gas.

### BACKGROUND OF THE INVENTION

1. Field of the Invention

The present invention relates to analysis and detection devices, and more particularly, to an analysis and detection device for gas chromatography.

2. Description of Related Art

Gas chromatography is a common analytic method, in which an object to be analyzed is carrier by a carrier gas such as nitrogen, hydrogen or helium through a separation column Generally, the separation column is filled with solid-phase particles, and there is a thin liquid layer on the surface of the solid-phase particles. When the object passes, the object is moved by the carrier gas and there is affinity between the thin liquid layer on the solid-phase particles and the object. The separation rate of compounds in the column depends on the affinity strength. Different compounds may have different affinity, which results in separation. The filler in the column may be varied to achieve different separation effect.

A gas chromatograph includes an injector, a separation column, a detector and a recorder. Conventionally, a gas is detected by a chemical method such as electron change amount due to combustion, charge-mass change due to hot electron bumping, electric property change due to a gas absorbed on a semiconductor component, and etc. The common detection methods may include a thermal conductivity detector (TCD), a flame ionization detector (FID) and a mass spectrometer (MS). The thermal conductivity detector is commonly used for detecting an organic compound having carbons such as carbon dioxide, but has relatively lower sensitivity. The flame ionization detector is used for detecting inorganic gases and organic compounds, but is not sensitive to carboxyl groups, alcohols, halogens, and amino groups. The mass spectrometer is used for measuring the charge-mass ratio, so as to analyze isotopes, organic structures and components. However, while using these detectors, a calibration curve is needed for quantitation, and there are many limitations for detecting inorganic gases, inert gases and materials, which are difficult to be ionized. Hence, there is a need to develop a simple detection device for various gases which has anticorrosion, long life and high sensitivity and also can be operated at high temperature and high pressure.

### SUMMARY OF THE INVENTION

The present invention provides an analysis and detection device, including a vaporization unit for vaporizing an object to form a gaseous sample; a separation unit for separating a plurality of single-component gases from mixed components of the gaseous sample; a detection unit for detecting each of the single-component gases to correspondingly form a sound signal; and a signal receiving unit for receiving the sound signal and transferring the sound signal into an electronic signal. The device of the present invention uses the principle of gas chromatography, wherein the gaseous sample passes through a whistle detection unit, a sound signal with a certain frequency is physically formed and received by a microphone with high sensitivity, and after Fourier transformation, a single peak is simultaneously detected. While detecting or monitoring, only the difference of frequencies needs to be read without any calibration curve, so as to directly obtain the concentration of the analyte. Hence, the present invention compensates the disadvantages of the commercial detector such as a thermal conductivity detector, a flame ionization detector, a semiconductor sensor and a mass spectrometer.

The present invention further provides an analysis and detection system, including a gas chromatography device and a detection device connected to the gas chromatography device, wherein the detection device produces a sound signal via a gas separated from the gas chromatography device and verify the components and their amounts of a gaseous sample according to occurrence time and frequency of the sound signal. In the analysis and detection system, the detection device produces a sound signal via gas resonance based on physical principle, and proceeds quantitation of components of the gaseous sample based on the frequency of the sound signal. For detecting a trace amount of the gaseous sample, the components and their amounts of the gaseous sample are determined by using the gas chromatography device and the occurrence time and frequency change of the sound signal. In addition, the system of the present invention may be also used for a transportation pipe at high temperature and high pressure or having dangerous gases, and perform the detection based on tiny frequency change of the gas in the pipe. The analysis and detection system of the present invention provides an immediate detection and quantitation for a gas, and is thus applicable in academic and industry.

### BRIEF DESCRIPTION OF THE DRAWINGS

FIG. 1 is a schematic view showing a structure of a whistle detection device according to the present invention;

FIG. 2 is a diagram showing a test result of the system of the present invention;

FIG. 3A is a diagram showing predicted values of the system according to Embodiment 1 of the present invention;

FIG. 3B is a diagram showing the test result of the system according to Embodiment 1 of the present invention;

FIG. 4 is a diagram showing the relationship between the sample volume and the frequency in Embodiment 2 of the present invention;

FIG. 5A is a diagram showing the relationship between the retention time and the frequency in Embodiment 3 of the present invention;

FIG. 5B is a diagram showing the relationship between the retention time and the frequency in Embodiment 4 of the present invention;

FIG. 6A is a diagram showing the relationship between the retention time and the strength in Comparative Example 1; and

FIG. 6B and FIG. 6C are diagrams showing the relationship between the retention time and the frequency in Embodiment 5 of the present invention.

### DETAILED DESCRIPTION OF THE PREFERRED EMBODIMENTS

The detailed description of the present invention is illustrated by the following specific examples. Persons ordinarily skilled in the art can conceive the other advantages and effects of the present invention based on the disclosure contained in the specification of the present invention.

The analysis and detection device of the present invention includes a vaporization unit, a separation unit, a detection unit and a signal receiving unit. In the analysis and detection device, an object is vaporized as a gaseous sample by the vaporization unit, and the gaseous sample is introduced into the separation unit by a carrier gas. The separation is performed based on the principle of gas chromatography. Mixed components of the gaseous sample are separated into a plurality of single-component gases, which are respectively introduced from the separation device to the detection unit by the carrier gas. The detection unit of the present invention is a whistle detector. When the gaseous sample passes through the whistle detector, a sound signal with a certain frequency is produced and received by the signal receiving unit, and after Fourier transformation, a single peak is simultaneously detected to be analyzed and compared. The quantitation of the components is determined according to the sequence and time at which the gaseous sample is introduced into the detection unit. In addition, the quantitation of the components is determined by the detection unit according to the sound signal of the gaseous sample, wherein the sound signal is changed in response to the components and their amounts of the gaseous sample.

In one embodiment, the quantitation of a specific component in the gaseous sample is determined by the detection unit according to the sound signal of the gaseous sample, wherein the sound signal is changed in response to the components and their amounts of the gaseous sample.

In one embodiment, the separation unit is a gas chromatography column, and after an object is vaporized as a gaseous sample, the gaseous sample is introduced into the gas chromatography column by a carrier gas such as hydrogen, oxygen, helium, argon, nitrogen or air. When the gaseous sample is introduced through the gas chromatography column by the carrier gas, components have various affinities to the fillers in the gas chromatography column. Each component passes through the column at a respective rate based on its affinity to the fillers of the column, such that the mixed components are separated. Then, each separated single-component gas is introduced into a detection unit by the carrier gas.

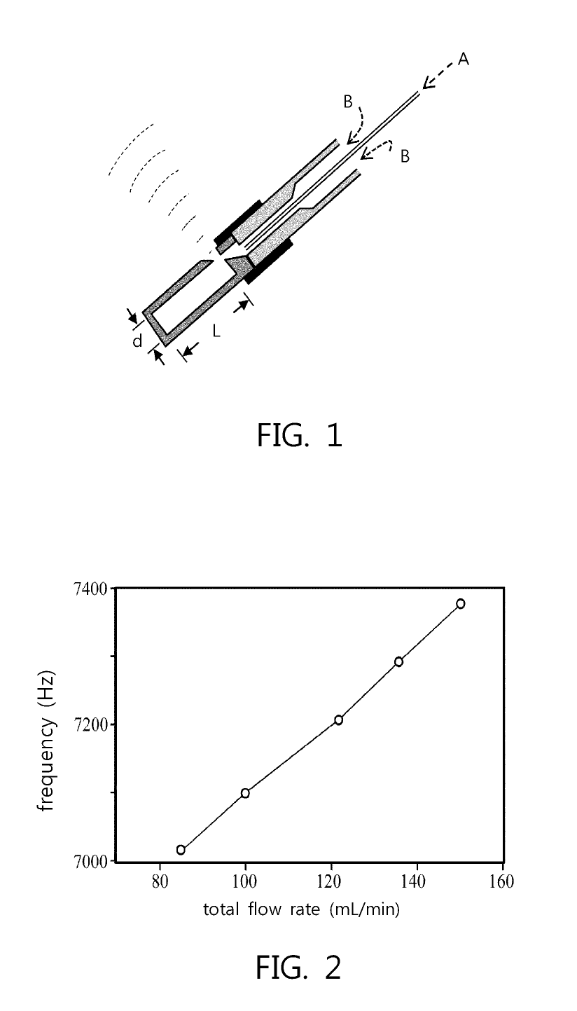

In the embodiment, the whistle detector is used as a detection unit, and a microphone with high sensitivity is used as a signal receiving unit. The size of the whistle detector is not limited as long as a sound signal may be produced in response to the gaseous sample. Generally, the diameter of the whistle detector is in a range from 1 to 5 mm, and the depth of the whistle detector is in a range from 6 to 25 mm The detection unit and the signal receiving unit are disposed in an enclosed sound insulation chamber. Each of the single-component gases separated from the gas chromatography column is introduced into the enclosed sound insulation chamber by the carrier gas as indicated by an arrow A in FIG. 1. Each of the single-component gases passes through the whistle detector to correspondingly form a sound signal, and the sound signal is received by the microphone with high sensitivity to be transferred into an electronic signal. In the embodiment, each of the single-component gases separated from the gas chromatography column is introduced into the detection unit by the carrier gas and a makeup gas as indicated by an arrow B. The makeup gas may be the same as or different from the carrier gas, and the quality of the sound signal of the single component may be improved by adjusting the flow rate of the makeup gas, so as to improve the sensitivity of the device.

The signal receiving unit is further connected to the information processing unit, wherein the electronic signal is transmitted to and stored in the information processing unit. In one embodiment, the information processing unit is a computer for receiving and storing the electronic signal from the signal receiving unit. The quantitation of the component is determined according to the occurrence time of the sound signal. In addition, the quantitation of the component may be determined based on the frequency change of the sound signal while the component passes through the detection unit.

The present invention provides an analysis and detection system coupled with gas chromatography. The analysis and detection system includes a gas chromatography device and a detection device connected to the gas chromatography device. In the detection device of the analysis and detection system, the quantitation and quality of the component are determined based the sound signal of the component separated from the gas chromatography according to the occurrence time and change of the sound signal. In the detection device of the analysis and detection system of the present invention, the quantitation of a specific component is determined according to the sound signal produced from the gas resonance and the frequency of the sound signal influenced by the change of the components. In the system of the present invention, there is no need to use expensive and complicated detectors. The system of the present invention may be used for detecting various gases, and have low cost, high sensitivity, tolerance to high temperature and pressure, resistance to corrosion and long lifetime.

The features and effects of the present invention are illustrated by, but not limited to, the follow embodiments.

### Test Example

The gas chromatography system (GC 5890; Hewlett-Packard, Avondale, Pa.) with DB-VRX (30 m×0.45 mm×1.4 um) chromatography column was used. The carrier gas was nitrogen, the flow rate was 14 mL/min, and the flow rate of the makeup gas, nitrogen, was 70 to 136 mL/min. The background pressure was 3 kg/cm². The injection volumes of the gas and liquid samples were controlled to be 3 to 90 μL per injection and 40 to 280 mL per injection. The micro whistle detector made of brass was used for detection, and has a diameter as 2 mm and a depth as 10 mm as shown in FIG. 1. The microphone was used as a signal receiving unit (PCB Piezotronics, Inc.; Model 426E01; acceptable range being 6.3 to 125000 Hz) All the units were disposed in an enclosed sound insulation chamber (stainless steel vacuum chamber, inner diameter/depth: 4 inches/10 cm). The frequency of the sound signal produced from the micro whistle detector was in a range from 7014 to 7380 Hz, and the relationship between the frequency of the sound signal and the total flow rate was shown in FIG. 2.

According to the test result, the frequency of the sound signal produced from the micro whistle detector may be calculated from the following equation (I) or equation (II).

f=(γRT/M)^{1/2}/4(L+0.4d) (□)

f is the frequency; d and L are the diameter and the depth of the enclosed channel of the micro whistle detector, respectively; and γ, R, T and M are heat capacity ratio (air:1.4), molar gas constant (8.31 J/K·mol), absolute temperature K and molar mass (air: 28.8×10⁻³ g/mole), respectively.

$$f = α \frac{\sqrt{\frac{γ RT}{( 1 - \frac{Vs}{Vm + Vc} ) \times 2 Δ t \times M c + \frac{Vs}{Vm + Vc} \times Ms}}}{4 ( L + 0.4 d )}$$

$$( • )$$

α is an experiment data correction coefficient; T is the temperature in the sound insulation chamber; γt is the width of the peak of the sample; Vs, Vm and Vc are volumes of the sample gas, the makeup gas and the carrier gas, respectively; and Mc and Ms are respectively molar mass of the carrier gas and the sample gas.

### Embodiment 1

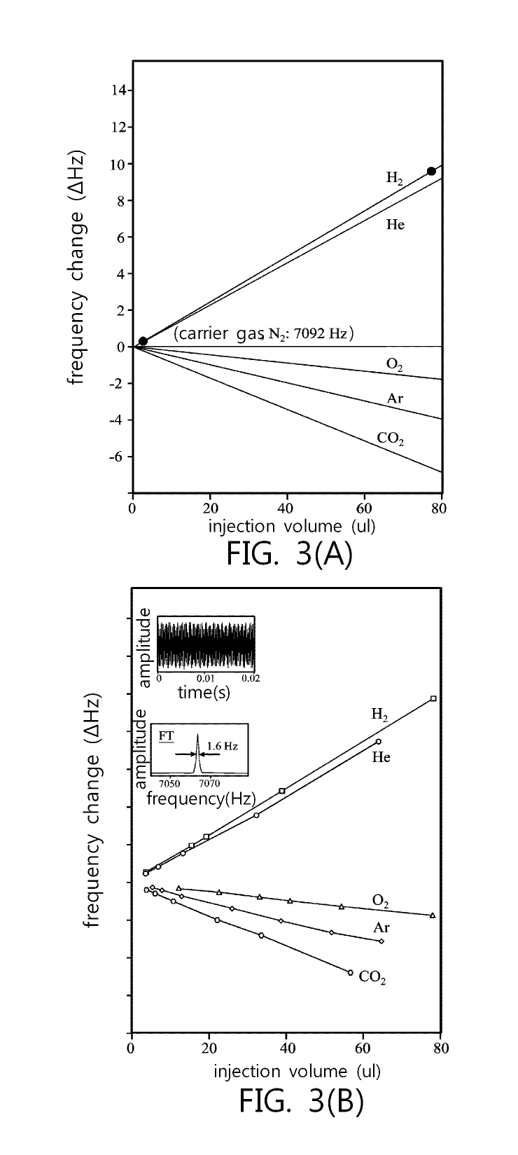

Hydrogen, Helium, oxygen, argon and carbon dioxide were used as gas samples, and the fundamental tone of the makeup/carrier nitrogen was 7092 Hz. The experiment data correction coefficients (a) of hydrogen, Helium, oxygen, argon and carbon dioxide were 0.94, 0.96, 0.64, 0.41 and 0.57, respectively, as shown in FIG. 3A and FIG. 3B.

As shown in FIG. 3A and FIG. 3B, the test result value in FIG. 3 B met the predicted value in FIG. 3A. For example, the correction coefficient α of hydrogen was 0.94; □t was 5.7 s; T was 25° C.; Vm and Vc were 125.2 mL and 14 mL, respectively; the sample volumes of hydrogen were 4 μL and 78 μL, respectively; and the test results were 7092.5 Hz and 7101.79 Hz (FIG. 3B, H₂) which met the calculation results, 7092.5 Hz and 7101.76 Hz (FIG. 3A, indicated as ·).

### Embodiment 2

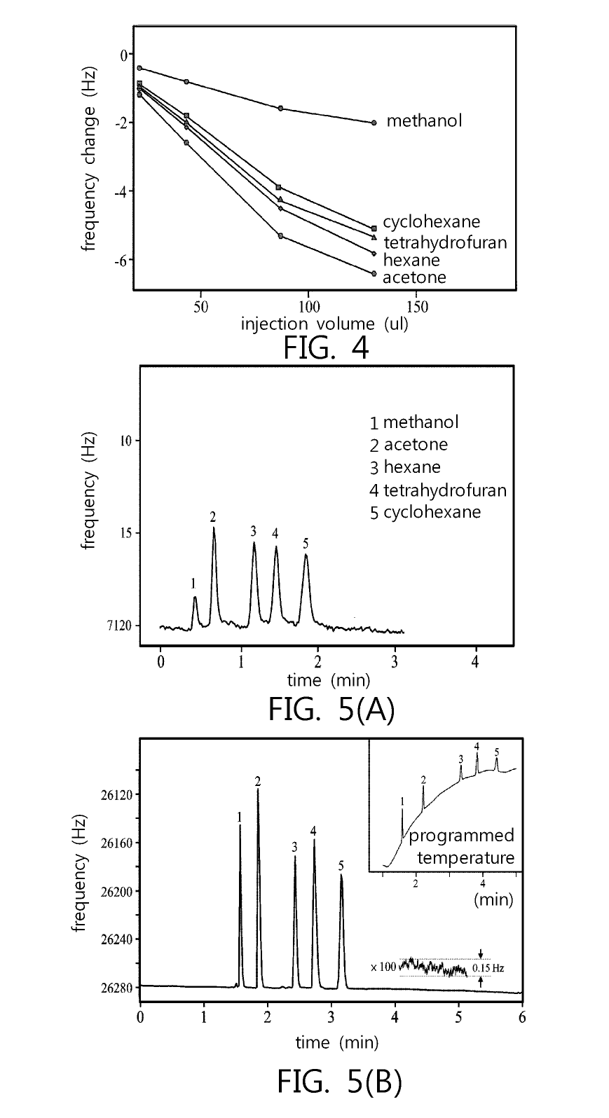

Methanol, cyclohexane, tetrahydrofuran, hexane and acetone were used for the test, the flow rate of the makeup/carrier hydrogen was 115/14 mL/min, the pressure was 15 psi, the temperature for the sample injection was 180° C., and the temperature of the column was 80° C. (5 minutes). FIG. 4 shows the relationship between the sample injection volume and the frequency change (□Hz).

### Embodiment 3

Methanol, cyclohexane, tetrahydrofuran, hexane and acetone were mixed for the test (mix ratio v/v:1/1), the flow rate of the makeup/carrier hydrogen was 140/14 mL/min, the sample injection volume was 76 mL, the temperature for the sample injection was 150° C., and the temperature of the column was 80° C. (5 minutes). After Fourier transformation, the relationship between the retention time of each component and the frequency change was shown in FIG. 5A.

### Embodiment 4

Methanol, cyclohexane, tetrahydrofuran, hexane and acetone were mixed for the test (mix ratio v/v:1/1), the flow rate of the makeup/carrier hydrogen was 280/6.8 mL/min, the sample injection volume was 40 mL, the temperature for the sample injection was 150° C., and the temperature of the column was 40° C. (0.5 min) and 40 to 70° C. at 10° C./min and held for 2 min. After Fourier transformation, the relationship between the retention time of each component and the frequency change was shown in FIG. 5B.

### Comparative Example 1

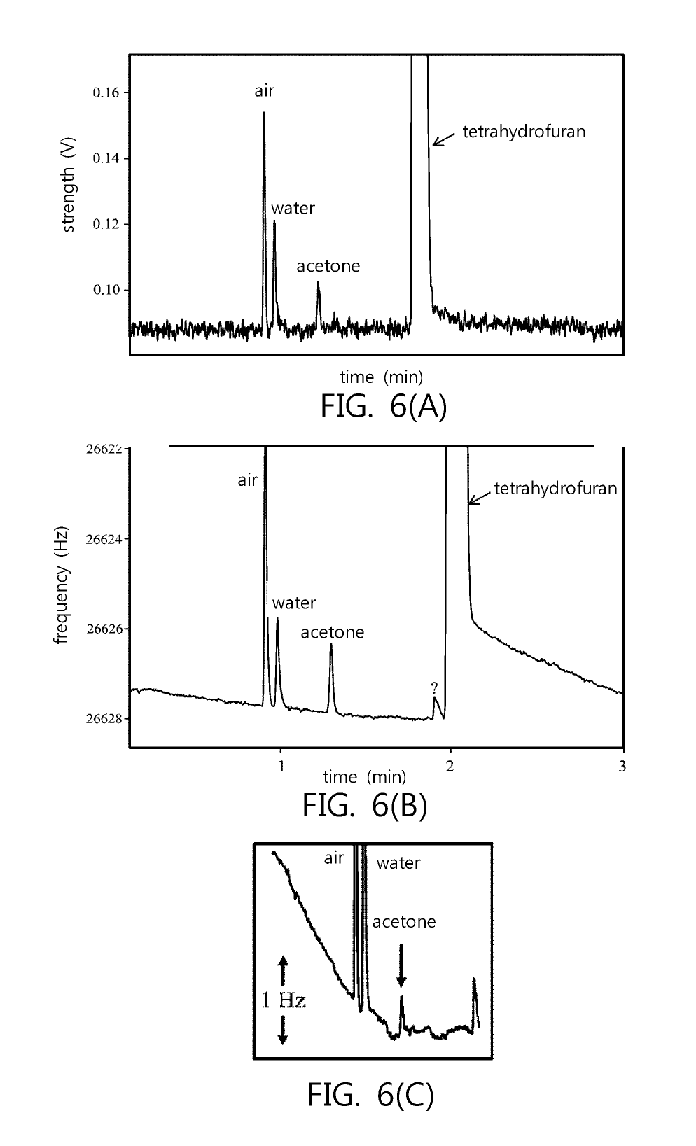

By using the sandwich injection type, 5 μL of acetone was added into 955 μL of THF to form a test sample. 0.4 μL of the test sample (1.6 μg of acetone) was injected, the sample injection temperature was 150° C., the temperature of the column was 80° C. (5 minutes), and the makeup/carrier gas was hydrogen. The thermal conductivity detector (TCD) was used at 220° C. and 4 psi, the reference gas was 8 mL/min, and the carrier gas was 6.8 mL. After Fourier transformation, the relationship between the retention time of each component and the frequency change was shown in FIG. 6A, wherein the change of the acetone strength (mV) was 0.02 V.

### Embodiment 5

The steps were performed as those in Comparative Example except that the flow rate of the makeup/carrier hydrogen was 280/6.8 mL/min, and the thermal conductivity detector was replaced with the micro whistle detector. After Fourier transformation, the relationship between the retention time of each component and the frequency change was shown in FIG. 6B, wherein the frequency change of acetone was 1.6 Hz.

Acetone was diluted into 1/10 with THF. The previous steps were repeated, and the minimal detection limit was about 0.1 μg. The results were shown in FIG. 6C.

According to the results of Comparative Example 1 and Embodiment 5, the detection range of the thermal conductivity detector (TCD) was about from 2 to 100 μg per injection, and the detection range of the micro whistle detector was about from 0.2 to 200 μg per injection, which was significantly better than that of the thermal conductivity detector.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. An analysis and detection device, comprising:
a vaporization unit for vaporizing an object to form a gaseous sample;
a separation unit for separating a plurality of single-component gases for detections from mixed components of the gaseous sample, wherein the gaseous sample is introduced from the vaporization unit into the separation unit by a carrier gas;
a detection unit for detecting each of the plurality of single-component gases to correspondingly form a sound signal, wherein the single-component gases are introduced from the separation unit into the detection unit by the carrier gas; and
a signal receiving unit for receiving the sound signal and transferring the sound signal into an electronic signal.

2. The analysis and detection device of claim 1, wherein the separation unit is a gas chromatography column.

3. The analysis and detection device of claim 1, wherein the carrier gas is one selected from the group consisting of hydrogen, oxygen, helium, argon, nitrogen and air.

4. The analysis and detection device of claim 1, wherein the detection unit and the signal receiving unit are disposed in an enclosed sound insulation chamber.

5. The analysis and detection device of claim 1, wherein the detection unit is a whistle detector.

6. The analysis and detection device of claim 1, wherein the signal receiving device is a microphone.

7. The analysis and detection device of claim 1, further comprising an information processing unit for receiving and storing the electronic signal.

8. The analysis and detection device of claim 7, wherein the information processing unit is a computer.

9. An analysis and detection system, comprising:
a gas chromatography device; and
a detection device connected to the gas chromatography device,
wherein the detection device produces a sound signal via a gas separated from the gas chromatography device.

10. The analysis and detection system of claim 9, wherein the detection device is a whistle detector.
